(19) United States
(12) Patent Application Publication
(10) Pub. No.: US 2021/0229545 A1
(43) Pub. Date: Jul. 29, 2021

(54) VEHICLE

(71) Applicant: TOYOTA JIDOSHA KABUSHIKI KAISHA, Aichi-ken (JP)

(72) Inventors: Jumpei WATANABE, Nagakute-shi (JP); Tomoharu KATAOKA, Yaizu-shi (JP); Masashi NOSE, Miyoshi-shi (JP)

(21) Appl. No.: 17/037,696

(22) Filed: Sep. 30, 2020

(30) Foreign Application Priority Data
Jan. 24, 2020 (JP) 2020-010340

(51) Int. Cl. B60K 11/04; B60L 50/60; B60L 58/10; B60N 2/00; B60N 2/56; B60N 3/02

(52) U.S. Cl. CPC B60K 11/04; B60L 50/60; B60L 58/10; B60N 3/02; B60N 2/5614; B60N 2/5692; B60N 2/002

(57) ABSTRACT

A vehicle is provided with a vehicle body equipped with an electric device that generates heat during traveling, a heat exchanger that exchanges heat between the outside air and a refrigerant, and a cooling tube that constitutes a flow passage for circulation of the refrigerant between the electric device and the heat exchanger, and in which a part of the flow passage directed from the electric device to the heat exchanger is laid in a vehicle cabin of the vehicle body.

### CROSS-REFERENCE TO RELATED APPLICATION

This application claims priority to Japanese Patent Application No. 2020-010340 filed on Jan. 24, 2020, incorporated herein by reference in its entirety.

### BACKGROUND

### 1. Technical Field

The disclosure relates to a vehicle.

### 2. Description of Related Art

Japanese Patent Application Publication 2014-108676 (JP 2014-108676 A) discloses a vehicle in which heat generated in a battery part is transferred to a cushion tank, and the heat is supplied from the cushion tank to various devices, thereby reusing the heat. Specifically, the heat is supplied from the cushion tank to a windshield, a headlight case, and the like to prevent fogging of the windshield, the headlight case, and the like.

### SUMMARY

However, in the vehicle disclosed in JP 2014-108676 A above, heat generated from an electric device such as a battery is temporarily transferred to the cushion tank, and hence there is room for improvement in effectively using exhaust heat.

In view of the fact described above, an object of the disclosure is to provide a vehicle capable of effectively using heat generated from an electric device.

A vehicle according to claim 1 includes: a vehicle body equipped with an electric device that generates heat during traveling; a heat exchanger that exchanges heat between the outside air and a refrigerant; and a cooling tube that constitutes a flow passage for circulation of the refrigerant between the electric device and the heat exchanger and in which a part of the flow passage from the electric device to the heat exchanger is laid in a vehicle cabin of the vehicle body.

In the vehicle according to claim 1, the vehicle body includes the electric device that generates heat during traveling. The heat exchanger exchanges heat between the outside air and the refrigerant. Further, the cooling tube constituting the flow passage that circulates the refrigerant between the electric device and the heat exchanger is provided. Thus, the refrigerant flowing in the cooling tube circulates between the electric device and the heat exchanger, thereby cooling the electric device.

A part of the flow passage of the cooling tube from the electric device to the heat exchanger is laid in the vehicle cabin of the vehicle body. As a result, the refrigerant, having taken heat in the electric device, releases the heat into the vehicle cabin while flowing through the vehicle cabin, and it is thus possible to use exhaust heat without temporarily storing heat in the cushion tank or the like. Note that the “electric device” referred to here includes a driving battery for storing electric energy, a power control unit for controlling an output of the driving battery, an electronic control unit (ECU) for performing various kinds of control, and the like.

In a vehicle according to claim 2, in claim 1, a vehicle seat is disposed in a vehicle cabin, and a part of the cooling tube constitutes a seat passage that is laid around the vehicle seat.

In the vehicle according to claim 2, the vehicle seat can be warmed by releasing heat from the refrigerant flowing in the seat passage to the vehicle seat.

In a vehicle according to claim 3, in claim 2, the vehicle seat is provided with a seat sensor capable of directly or indirectly detecting a seating state of a passenger, the cooling tube is provided with a valve that is capable of opening and closing the seat passage by being controlled by a control unit, and the control unit opens the valve to allow the refrigerant to flow into the seat passage when a passenger is seated on the vehicle seat according to a signal from the seat sensor.

In the vehicle according to claim 3, when it is detected by the seat sensor that the passenger is seated, the control unit brings the valve into an open state, and the refrigerant flows into the seat passage. Thus, the vehicle seat on which the passenger is seated can be warmed. On the other hand, when it is not detected by the seat sensor that the passenger is seated, the valve comes into a closed state, and the refrigerant does not flow into the seat passage. This makes it possible to ensure a large amount of heat released in other portions inside the vehicle cabin.

In a vehicle according to claim 4, in any one of claims 1 to 3, a part of the cooling tube constitutes a handrail to be held by the passenger.

In the vehicle according to claim 4, by the passenger holding the handrail, heat can be transferred from the refrigerant to the hand of the passenger via the handrail.

In a vehicle according to claim 5, in any one of claims 1 to 4, the electric device includes a driving battery.

In the vehicle according to claim 5, the driving battery is cooled by the refrigerant to maintain proper temperature, thereby extending a driving range of the vehicle. Further, the inside of the vehicle cabin can be warmed by using the heat of the driving battery.

In a vehicle according to claim 6, in claim 5, the electric device includes a power control unit that controls an output of the driving battery.

In the vehicle according to claim 6, the power control unit is cooled by the refrigerant, so that an arithmetic processing capacity can be maintained well. In addition, the inside of the vehicle cabin can be warmed by using the heat of the driving battery.

As described above, according to the vehicle of claim 1, the heat generated from the electric device can be used effectively.

According to the vehicle of claim 2, the comfort of the passenger seated on the vehicle seat can be improved.

According to the vehicle of claim 3, the inside of the vehicle cabin can be heated effectively.

According to the vehicle of claim 4, the hand of the passenger can be warmed directly.

According to the vehicle of claim 5, the inside of the vehicle cabin can be warmed while the driving battery is cooled.

According to the vehicle of claim 6, the inside of the vehicle cabin can be warmed while the power control unit is cooled.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic side view showing a main part of a vehicle according to an embodiment;

FIG. 2 is a schematic perspective view showing a main part in a vehicle cabin of the vehicle according to the embodiment;

FIG. 3 is a schematic sectional view of the vehicle according to the embodiment viewed from a vehicle rear side; and

FIG. 4 is a block diagram showing a hardware configuration of the vehicle according to the embodiment.

### DETAILED DESCRIPTION OF EMBODIMENTS

A vehicle 10 according to an embodiment will be described with reference to the drawings. Note that arrows FR, UP, and RH, appropriately drawn in each drawing, respectively indicate a forward direction, an upward direction, and a right-hand direction of the vehicle. Hereinafter, when directions of front and rear, up and down, and right and left are used for description, unless otherwise specified, these represent front and rear in a vehicle front-rear direction, up and down in a vehicle-height direction, and right and left in the case of facing a vehicle front direction.

Overall Configuration

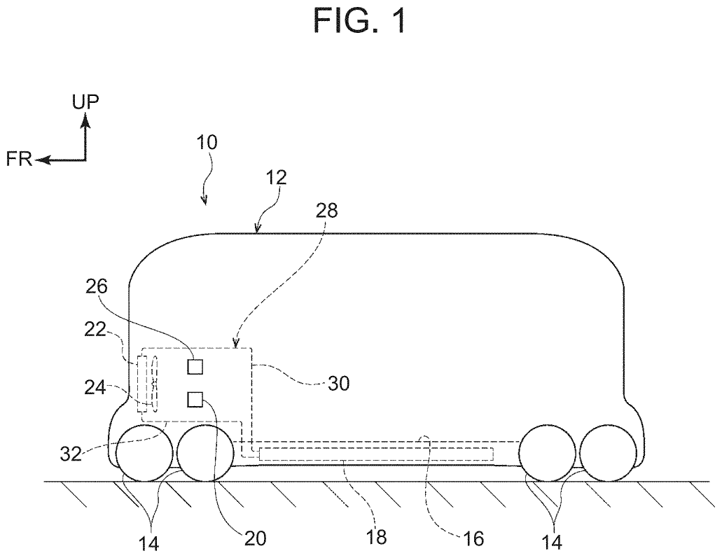

As shown in FIG. 1, the vehicle 10 of the present embodiment includes a vehicle body 12. The vehicle body 12 of the present embodiment, for example, has an outer shape symmetrical in the vehicle front-rear direction and can travel in both directions of the vehicle front-rear direction.

The vehicle body 12 includes a plurality of wheels 14. In the present embodiment, four wheels 14 are provided on a lateral portion of the vehicle body 12 on one side, and four wheels 14 are provided on the other side surface of the vehicle body 12. Of the four wheels 14 provided on the lateral portion on the one side, two wheels 14 are provided on a vehicle front side, and the remaining two wheels 14 are provided on a vehicle rear side. In FIG. 1, only four wheels 14 provided on the lateral portion of the vehicle body 12 are shown.

A driving battery 18 as an electric device is provided below a floor panel 16 constituting the vehicle body 12, and the driving battery 18 generates heat during traveling of the vehicle 10. The driving battery 18 is provided at a central portion of the vehicle body 12 in the vehicle front-rear direction and is electrically connected to a motor (not shown) configured to drive the vehicle 10. When power is supplied from the driving battery 18 to the motor, the motor is driven to cause the vehicle 10 to travel. Note that one motor may be provided on one side in the vehicle front-rear direction. Each wheel 14 may be provided with an in-wheel motor.

The driving battery 18 is connected to a power control unit 20 (hereinafter referred to appropriately as “PCU 20”) as an electric device that controls an output of the driving battery 18, and a motor (not shown) is connected to the PCU 20. The PCU 20 includes an inverter capable of converting alternating-current (AC) power into direct-current (DC) power and converting DC power into AC power and is configured to supply the power from the driving battery 18 to the motor via the PCU 20.

A radiator 22 as a heat exchanger is provided at an end of the vehicle body 12 on the vehicle front side, and a fan 24 is provided on a rear side of the radiator 22. The vehicle body 12 is provided with an electronic control unit (ECU) 26 as a control unit that controls the fan 24.

The radiator 22 is provided behind an opening (not shown) formed at a front end of the vehicle body 12 and is configured such that during traveling of the vehicle body 12, a traveling wind is introduced into the radiator 22 through the opening. When the fan 24 is operated as well, the outside air is introduced into the radiator 22 from the outside of the vehicle body 12 through the opening.

The radiator 22 and the driving battery 18 are coupled by a cooling tube 28 that circulates a refrigerant. Specifically, the cooling tube 28 includes a heat-releasing cooling tube 30 through which the refrigerant, having passed through the inside of the driving battery 18, flows into the radiator 22, and a heat-absorbing cooling tube 32, through which the refrigerant, having passed through the radiator 22, flows into the driving battery 18. The radiator 22 and the PCU 20 are coupled by a similar cooling tube 28. In the present embodiment, as an example, the heat-releasing cooling tube 30 after passing through the driving battery 18 passes through the PCU 20. In the present embodiment, coolant is used as the refrigerant.

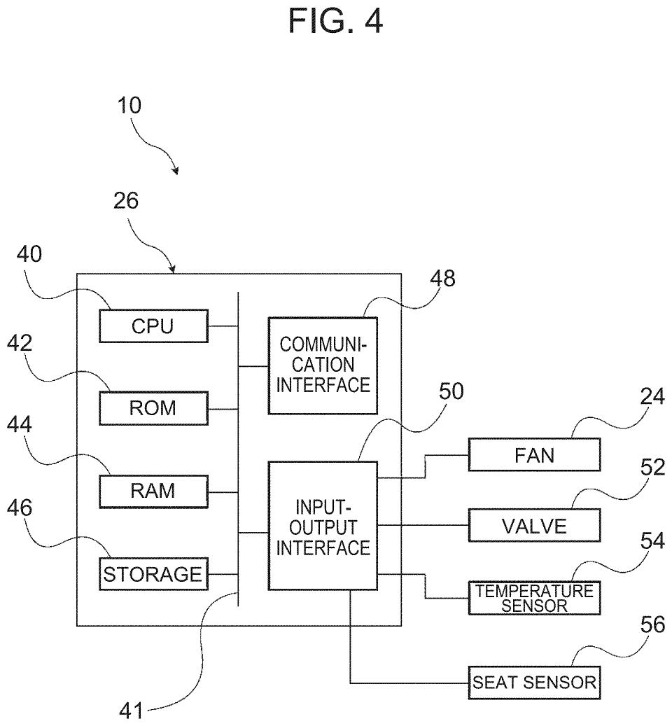

The cooling tube 28 is provided with a pump (not shown) and a valve 52 (see FIG. 4). When the driving battery 18 needs to be cooled, the ECU 26 controls the refrigerant so as to be circulated in the cooling tube 28. Thus, by circulating the refrigerant among the driving battery 18, the PCU 20, and the radiator 22, the refrigerant which has reached a low temperature due to heat exchange with the outside air by the radiator 22 flows along the driving battery 18 and the PCU 20.

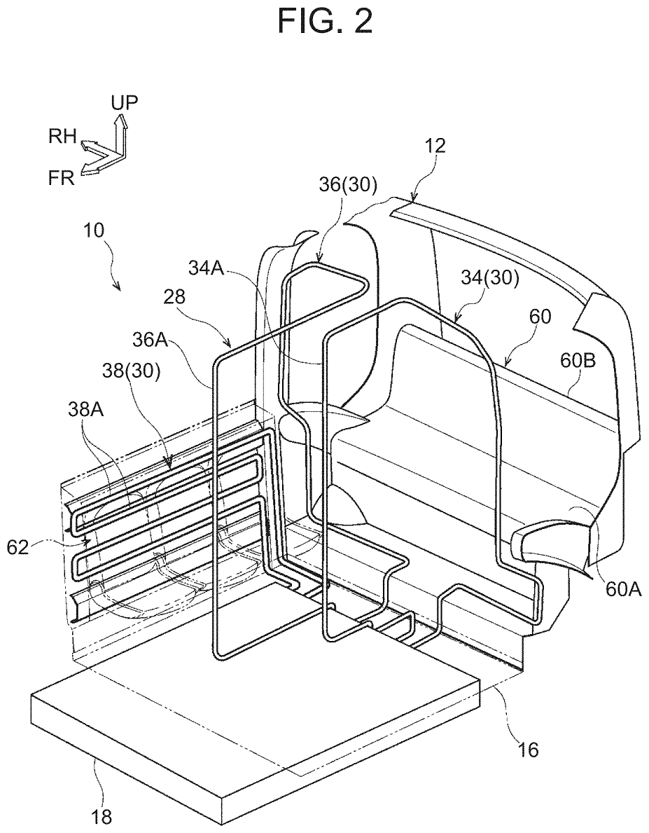

FIG. 1 schematically shows only a part of the heat-releasing cooling tube 30. FIG. 2 shows another part of the heat-releasing cooling tube 30.

Configuration of Heat-releasing Cooling Tube

As shown in FIG. 2, in the cooling tube 28, a part of the heat-releasing cooling tube 30, which is directed from the driving battery 18 as the electric device to the radiator 22, is laid in a vehicle cabin. The heat-releasing cooling tube 30 includes a first flow passage 34, a second flow passage 36, and a third flow passage 38. The first flow passage 34, the second flow passage 36, and the third flow passage 38 are coupled via a plurality of valves 52 (see FIG. 4), and the refrigerant can flow only to an arbitrary flow passage by opening and closing the valve 52.

The first flow passage 34 is extended rearward from a rear end of the driving battery 18 along the floor panel 16 and is further extended to the left side in the vehicle width direction. The first flow passage 34 is extended upward to a ceiling along a pillar garnish (not shown) and is extended forward along the ceiling. Further, the first flow passage 34 is suspended from the ceiling toward the floor panel 16, and this vertically extended portion constitutes a handrail 34A to be held by a passenger.

The second flow passage 36 is extended rearward from the rear end of the driving battery 18 along the floor panel 16 and is further extended to the right side in the vehicle width direction. The second flow passage 36 is extended upward to the ceiling along the pillar garnish and is extended forward of the first flow passage 34 along the ceiling. Further, the second flow passage 36 is suspended from the ceiling toward the floor panel 16 on the vehicle front side of the first flow passage 34, and this vertically extended portion constitutes a handrail 36A to be held by the passenger. That is, in the present embodiment, as an example, two handrails, which are extended vertically and held by the passengers, are provided. The coolant flowing in each of the first flow passage 34 and the second flow passage 36 flows upward to the ceiling by operation of a pump (not shown), and the coolant flows downward under its own weight in the portion of each of the handrail 34A and the handrail 36A.

Note that the first flow passage 34 and the second flow passage 36 may be laid on a rear surface side of the pillar garnish or may be laid on a front surface side of the pillar garnish. When laid on the front surface side of the pillar garnish, the first flow passage 34 and the second flow passage 36 can function as handrails for the passenger seated on a bench seat 60 provided in the rear of the vehicle. That is, the bench seat 60 including a seat cushion 60A and a seatback 60B is provided in the rear of the vehicle body 12. The first flow passage 34 is located in front of a left end of the bench seat 60, and the second flow passage 36 is located in front of a right end of the bench seat 60. Therefore, the passenger seated at the left end of the bench seat 60 can hold the first flow passage 34 with his or her left hand. The passenger seated at the right end of the bench seat 60 can hold the second flow passage 36 with his or her left hand.

The third flow passage 38 is laid along a right side surface of the vehicle cabin. Specifically, the third flow passage 38 is extended rightward in the vehicle from the rear end of the driving battery 18 to the right side surface of the vehicle along the floor panel 16. The third flow passage 38 is extended upward along the right side surface of the vehicle cabin to an upper end of a vehicle seat 62 to be described later and is further extended to the vehicle front side. The third flow passage 38 is extended downward while meandering along the right side surface of the vehicle cabin. Hereinafter, the configuration of the right side surface of the vehicle cabin will be described specifically.

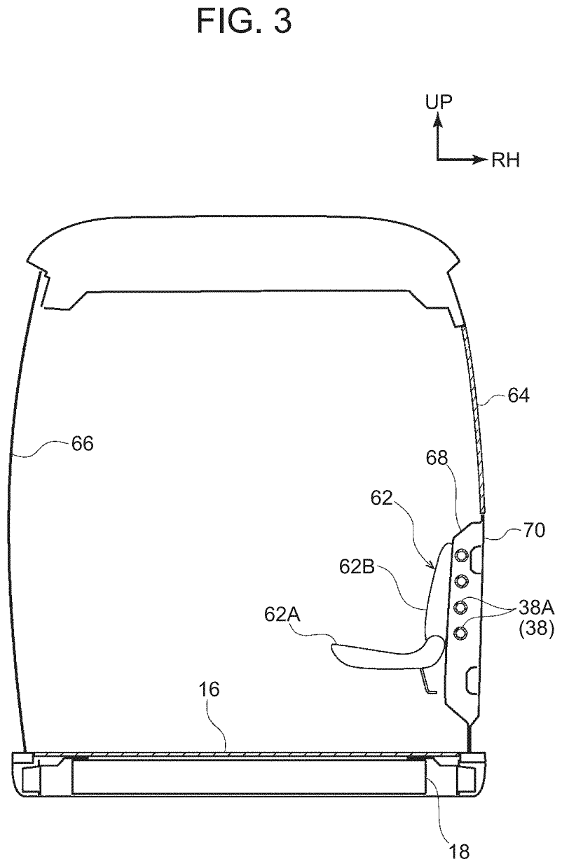

As shown in FIG. 3, a large sliding door 66 is provided on a left side surface of the vehicle body 12 of the present embodiment. Meanwhile, a side member outer panel 70 is disposed on the right side surface of the vehicle body 12. The side member outer panel 70 is located in a lower portion of the vehicle body 12 and constitutes an outer plate of the vehicle body 12. A side glass 64 is disposed above the side member outer panel 70.

A substantially plate-shaped seat fixing plate 68 is disposed inside the side member outer panel 70 in the vehicle width direction. The seat fixing plate 68 is formed in a hat-shaped cross section viewed from the vehicle front-rear direction and forms a closed cross section with the side member outer panel 70. The vehicle seat 62 is fixed to the seat fixing plate 68 via a bracket (not shown).

A plurality of vehicle seats 62 are arranged in the vehicle front-rear direction, and in the present embodiment, three vehicle seats 62 are arranged as an example (see FIG. 2). The vehicle seat 62 includes a seat cushion 62A and a seatback 62B, and a back surface of the seatback 62B is fixed to the seat fixing plate 68.

The seat cushion 62A is pivotably coupled to the seatback 62B, and a spring (not shown) for biasing the seat cushion 62A toward the seatback 62B is provided on a pivot shaft between the seat cushion 62A and the seatback 62B. Hence in an unloaded state, the seat cushion 62A is pivoted to the seatback 62B to be folded. At the time when the passenger is seated, the passenger can use the vehicle seat 62 by being seated with the seat cushion 62A pushed down against the biasing force of the spring.

The third flow passage 38 constituting the heat-releasing cooling tube 30 constitutes a seat passage 38A that is laid in a meandering manner along the seat fixing plate 68. The seat passage 38A is laid around the vehicle seat 62. As shown in FIG. 3, in a cross section viewed from the vehicle rear side, a plurality of seat passages 38A are arranged vertically along the seat fixing plate 68 and the seatback 62B, and in the present embodiment, four seat passages 38A are arranged as an example.

Hardware Configuration

As shown in FIG. 4, the ECU 26 includes a central processing unit (CPU) (processor) 40, a read-only memory (ROM) 42, a random-access memory (RAM) 44, a storage 46, a communication interface 48, and an input-output interface 50. Each of the constituents is communicably connected to one another via a bus 41.

The CPU 40 is a central processing unit that executes various programs and controls each unit. That is, the CPU 40 reads a program from the ROM 42 or the storage 46 and executes the program using the RAM 44 as a work area. The CPU 40 controls each of the constituents and performs various kinds of arithmetic processing in accordance with a program recorded in the ROM 42 or the storage 46.

The ROM 42 stores various programs and various pieces of data. The RAM 44 temporarily stores a program or data as a work area. The storage 46 is made of a hard disk drive (HDD) or a solid-state drive (SSD) and stores various programs including an operating system, and various pieces of data.

The communication interface 48 is an interface for the vehicle body 12 to communicate with an external device, and for example, a standard such as Ethernet (registered trademark), fiber-distributed data interface (FDDI), or Wi-Fi (registered trademark) is used.

The input-output interface 50 is electrically connected to the fan 24, the valve 52, a temperature sensor 54, and a seat sensor 56. The fan 24 is rotated by being operated to introduce the outside air into the radiator 22. A plurality of valves 52 are provided in the cooling tube 28 and configured to be independently openable and closable. The valve 52 is opened and closed to allow the refrigerant to flow in an arbitrary flow passage.

The temperature sensor 54 is provided near the driving battery 18, detects a temperature of the driving battery 18, and transmits the detected temperature to the ECU 26. The ECU 26 then controls the valve 52 in accordance with the temperature of the driving battery 18 detected by the temperature sensor 54, thereby maintaining the temperature of the driving battery 18 within a fixed range. For example, when the temperature of the driving battery 18 is lower than a predetermined threshold, the ECU 26 controls the valve 52 such that the refrigerant bypasses the driving battery 18 and directly flows to the PCU 20. Note that a plurality of temperature sensors 54 may be disposed along the driving battery 18. In this case, the valve 52 may be controlled so as to cool only a part of the driving battery 18.

The seat sensor 56 is provided on the vehicle seat 62 and can directly or indirectly detect a seating state of the passenger. As an example, the seat sensor 56 of the present embodiment is provided on a pivot shaft between the seat cushion 62A and the seatback 62B of the vehicle seat 62 and detects the opening of the seat cushion 62A. When the ECU 26 indirectly detects that the passenger is seated on the vehicle seat 62 in accordance with a signal from the seat sensor 56, the ECU 26 opens the valve 52 to allow the refrigerant to flow into the seat passage 38A. In place of the seat sensor 56, a seating sensor may be provided inside the seat cushion 62A. In this case, it is possible to directly detect that the passenger is seated.

Action

Next, an action of the present embodiment will be described.

In the vehicle 10 of the present embodiment, the refrigerant flowing in the cooling tube 28 circulates between the driving battery 18 and the PCU 20 and the radiator 22 to cool the electric device. A part of the heat-releasing cooling tube 30 of the cooling tube 28 is laid in the vehicle cabin of the vehicle body 12. As a result, the refrigerant, having taken heat in the driving battery 18 and the PCU 20, releases the heat into the vehicle cabin while flowing in the vehicle cabin, and it is thus possible to use exhaust heat without temporarily storing heat in a cushion tank or the like. As a result, the heat generated from the electric device can be used effectively.

Further, in the present embodiment, the vehicle seat 62 can be warmed by releasing heat to the vehicle seat 62 from the refrigerant that flows in the seat passage 38A constituting the heat-releasing cooling tube 30, and the comfort of the passenger seated on the vehicle seat 62 can be improved. In particular, in the present embodiment, when it is detected by the seat sensor 56 that the passenger is seated, the ECU 26 brings the valve 52 into an open state and the refrigerant flows in the seat passage 38A, so that the vehicle seat 62 on which the passenger is seated can be warmed. On the other hand, when it is not detected by the seat sensor 56 that the passenger is seated, the valve 52 comes into a closed state, and the refrigerant does not flow in the seat passage 38A, so that a large amount of heat released can be ensured in the first flow passage 34 and the second flow passage 36. As a result, the inside of the vehicle cabin can be heated effectively.

Further, in the present embodiment, each of the first flow passage 34 and the second flow passage 36 constitutes the handrail. Thus, by the passenger holding the handrail, heat can be transferred from the refrigerant to the hand of the passenger via the handrail. That is, the hand of the passenger can be warmed directly. In addition, by extending the first flow passage 34 and the second flow passage 36 along a skeleton member such as a pillar, the collision resistance performance of the vehicle body 12 can be improved

Further, in the present embodiment, the driving battery 18 is cooled by the refrigerant to be maintained at proper temperature, thereby extending a driving range of the vehicle 10. The inside of the vehicle cabin can be warmed by using the heat of the driving battery 18. That is, the inside of the vehicle cabin can be warmed while the driving battery is cooled.

In the present embodiment, the PCU 20 is cooled by the refrigerant, so that an arithmetic processing capacity can be maintained well. The inside of the vehicle cabin can be warmed by using the heat of the PCU 20. That is, the inside of the vehicle cabin can be warmed while the PCU 20 is cooled.

Although the vehicle 10 according to the embodiment has been described above, it is needless to say that the disclosure can be implemented in various forms without departing from the gist of the disclosure. For example, in the above embodiment, the handrail 34A has been made of the first flow passage 34 and the handrail 36A has been made of the second flow passage 36 as shown in FIG. 2, but the disclosure is not limited thereto. That is, only the first flow passage 34 may be provided. A handrail may be provided separately from the handrail 34A and the handrail 36A. Further, portions of the first flow passage 34 and the second flow passage 36 extending in the vehicle front-rear direction may be exposed in the vehicle cabin as handrails.

In the above embodiment, the cooling tube 28 totally has the same configuration, but the disclosure is not limited thereto. For example, a heat insulation structure may be varied between the heat-releasing cooling tube 30 and the heat-absorbing cooling tube 32 that constitute the cooling tube 28. The heat-absorbing cooling tube 32 may have a structure with higher heat insulation performance because it is necessary to flow the refrigerant, which has been heat-exchanged with the outside air in the radiator 22, to the driving battery 18 and the PCU 20 in a low-temperature state. On the other hand, the heat-releasing cooling tube 30 may have a structure with low heat insulation performance so as to promote the heat release in the vehicle cabin. Particularly when the heat-releasing cooling tube 30 constituting the portion of each of the handrail 34A and the handrail 36A is made of a material with high heat conductivity, the hand of the passenger can be more effectively warmed and the inside of the vehicle cabin can be warmed.

In the above embodiment, as shown in FIG. 3, the seat passage 38A has been provided in the space between the side member outer panel 70 and the seat fixing plate 68, but the disclosure is not limited thereto, and the same action can be achieved by laying the seat passage 38A around the vehicle seat 62. For example, the seat passage 38A may be laid inside the seatback 62B constituting the vehicle seat 62. The seat passage 38A may be laid inside the seat cushion 62A. Further, a seat passage may be separately laid inside the bench seat 60 shown in FIG. 2.

Although the seat sensor 56 has been provided in the above embodiment, the disclosure is not limited thereto, and the seat sensor 56 may not be provided.

Although the driving battery 18 and the PCU 20 have been cooled as the electric devices in the present embodiment, the disclosure is not limited thereto. For example, a motor (not shown) may be used as the electric device. An ECU or the like to be used for control during automated driving may be used as the electric device. Unlike the driving battery 18, the PCU 20 and the ECU 26 need to be always cooled during traveling, so that the inside of the vehicle cabin can be warmed efficiently by using exhaust heat.

Although the radiator 22 has been used as the heat exchanger in the above embodiment, the disclosure is not limited thereto. That is, another heat exchanger may be used so long as being a device capable of exchanging heat between the outside air and the refrigerant.

Moreover, the vehicle 10 of the above embodiment has been the electric vehicle with the motor as a drive source, but the disclosure is not limited thereto. For example, the disclosure may be applied to a hybrid vehicle with an engine and a motor as drive sources.

What is claimed is:

1. A vehicle comprising:
a vehicle body equipped with an electric device that generates heat during traveling;
a heat exchanger that exchanges heat between outside air and a refrigerant; and
a cooling tube that constitutes a flow passage for circulation of the refrigerant between the electric device and the heat exchanger and in which a part of the flow passage from the electric device to the heat exchanger is laid in a vehicle cabin of the vehicle body.

2. The vehicle according to claim 1, wherein
a vehicle seat is disposed in the vehicle cabin, and
a part of the cooling tube constitutes a seat passage that is laid around the vehicle seat.

3. The vehicle according to claim 2, wherein
the vehicle seat is provided with a seat sensor capable of directly or indirectly detecting a seating state of a passenger,
the cooling tube is provided with a valve that is capable of opening and closing the seat passage by being controlled by a control unit, and
the control unit opens the valve to allow the refrigerant to flow into the seat passage when the passenger is seated on the vehicle seat according to a signal from the seat sensor.

4. The vehicle according to claim 1, wherein a part of the cooling tube constitutes a handrail to be held by the passenger.

5. The vehicle according to claim 1, wherein the electric device includes a driving battery.

6. The vehicle according to claim 5, wherein the electric device includes a power control unit for controlling an output of the driving battery.
